(19) United States
(12) Patent Application Publication
(10) Pub. No.: US 2008/0192205 A1
(43) Pub. Date: Aug. 14, 2008

(54) Projection Display Device

(75) Inventor: Adrianus Johannes Stephanus Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,369

(22) PCT Filed: Oct. 17, 2005
(86) PCT No.: PCT/IB2005/053400

§ 371 Date: Apr. 17, 2007

(30) Foreign Application Priority Data
Oct. 22, 2004 (EP) 04105239.0

(51) Int. Cl. G02B 27/18; G02B 27/28

(52) U.S. Cl. 353/20; 359/485

(57) ABSTRACT

The image homogeneity as well as the light effectiveness of a display device is improved by the introduction of a polarization dependent diffuser and a reflective polarizer between the light source and the LCD panel in the display device system. The image quality is improved since the diffuser broadens light incident on the LCD panel. The light effectiveness is improved as the polarizer reflects non-diffused light, confined, such that it can be recycled by light guiding means, in the display device, for re-illumination of the image display panel.

### TECHNICAL FIELD

The present invention generally relates to a display device for displaying images, and more specifically display device comprising a light guide and a spatial light modulator (SLM).

### BACKGROUND

There are two major types of image display systems comprising light guides and SLMs. One is image projection systems or projectors, and the other is direct view display devices. In both these types of systems light guides are used to direct a major or minor part of the illumination from the light source towards an image modulation device.

Projectors can be used in both rear and front image projection systems. In a rear projection system, a projector projects an image representing television or datagraphic information on the rear side of a diffusing transparent screen, which front side is directed to a viewing audience. In a front projection system, the projector projects an image representing television or datagraphic information on the front side of a reflecting screen, which front side is directed to a viewing audience.

Below is given a basic description of a conventional front LCD projector. In this projection system there is a light source and a light collection system, consisting of a parabolic reflector and lens plates, to direct the light in the desired direction. Further, there is a series of integrators and lenses to shape the beam in the right dimensions and geometry, and to obtain a uniform distribution of the light intensity over the cross-section of the beam. The projector also includes pre-polarization optics such as a polarization conversion system (PCS) consisting for example of a flat multi polarizing beam splitter. The PCS is largely able to convert unpolarized light into polarized light. As in most transmissive front projectors, the white light is thereafter split into the primary colors red, green and blue, by means of color splitting optics or dichroic mirrors. The three different colored light beams are sent through three different light valves. Each light valve includes a polarizer, a LCD panel and an analyzer. The light valve can either transmit or block the light. It is possible to switch between the bright state and the dark state by changing the orientation of the LC molecules in the LCD panel, which can be accomplished by changing the electrical field over the LC layer. The three different colors are thereafter recombined in a single full color image by means of a dichroic cube or similar, and finally the image is projected by means of imaging projection optics.

Additionally, the image projection system can be provided with an light recycling functionality or a wave guide, such that light that is reflected from a further part of the light path can be recycled and used to re-illuminate the LCD panel, see for example EP 1 391 776. In this way e.g. polarization recycling, color recycling and peak brightness generation can be used to increase the system efficiency and the brightness of the generated image.

In order to meet commercial demands for image projection systems, there is a constant aim to produce such systems, which are smaller, have a longer life time and project brighter pictures with better contrast and homogeneity.

When designing the optical light guiding means or wave guides in the image projection system, one has to consider at least two conflicting requirements. On the one hand, in order to achieve a homogeneous illumination a high number of reflections and, therefore, a long light guide is desirable. On the other hand, in order to achieve a high system efficiency and a small from factor, the length of the light guide, the number of reflections and the angular distribution of the light should be limited. As a fraction of the light is lost at each reflection.

### DESCRIPTION OF THE INVENTION

An object of the present invention is to provide an improved optical arrangement for use in an display device, and in particular in a display device comprising one or several optical light guides.

The invention is based on an insight that an image with a more homogeneous intensity distribution can be generated by a display device comprising a light source and an image modulation panel, without any substantial loss of light, if one polarization direction of the light is diffused before it reaches the light modulation panel and, advantageously, the other polarization direction is reflected back into the light guide without being diffused. In this way the not-reflected, but directly transmitted, will be slightly diffused and therefore generate a more homogeneous image. At the same time light beam will be confined, and will have a small distribution angle. This means e.g. that less light will be lost or absorbed in the light guide. Consequently, more of the reflected light is able to re-appear at the diffuser. Moreover, light initially having said first polarization direction might, after being reflected inside the light guide, re-appear at the diffuser having a changed polarization state. In this way, a substantial portion of the light initially reflected by the polarizer, will re-appear at the diffuser with a changed polarization state, and can therefore be used in the projected image, and is thereto substantially confined.

Although the invention is described in relation to image devices comprising an LCD panel, it will be obvious to the man skilled in the art that the invention is also applicable to many other light modulating systems.

The object of the present invention is achieved by an image projection system, an optical element and use in accordance with the appended claims 1, 9 and 11. Preferred embodiments are defined in the dependent claims.

According to a first aspect thereof, the present invention provides a display device, which comprises a light source, an illumination system, a modulation panel for modulating the illumination beam with image information and projection means for projecting said modulated illumination beam on a screen. It also comprises diffusing means for diffusing a first portion of the illumination beam having a first polarization direction and transmitting a confined second portion of the illumination beam having a second polarization direction. Further, it comprises polarizing means, functionally arranged between said diffusing means and said modulation panel, for transmitting said first portion of the illumination beam to said modulation panel, and preventing said second portion of the illumination beam from reaching said modulation panel.

In this description the expression “a device being functionally arranged between a first and a second element” means that the device is arranged between these elements, although there might be other components arranged between one of the element and the device.

According to a second aspect thereof, the present invention provides an optical element for use in an image projection system as described above.

According to a third aspect thereof, the present invention relates to the use of a diffusing polarizer.

One advantage associated with the three aspects mentioned above is that they provide a better perceived quality of the projected image, due to a more homogeneous intensity distribution. Another advantage is that this is achieved without adding any substantial volume or any time consuming alignment procedures to the optical system. A third advantage is that the polarizing diffuser is cost effective and easy to manufacture.

According to one embodiment of the invention the display device is an image projection system.

According to another embodiment of the invention the display device is a direct view system.

Advantageously, the polarizing means is a reflective polarizer arranged such that said confined second polarization direction is reflected by the polarizer, and said diffused first polarization direction is transmitted through the polarizer. As stated above, said diffused first polarization direction will give a more homogeneous intensity distribution in the projected image. However, when the light having said second direction of polarization is reflected, it passes the diffuser a second time without being spread, and is preferably re-entered into the illumination system. There, it is reflected against the walls of the light guiding means until it eventually reappears at the diffuser, if it is not absorbed or scattered elsewhere. At these reflections the polarization direction of the reflected light might change, such that when the light re-appears at the diffuser it has said first polarization direction. Alternatively, the polarization direction of the re-appearing light is changed between the diffuser and reflecting polarizer, by e.g. a reflection in the wall between the diffuser and the polarizer. Hence, as it now has said first direction of polarization, it will be diffused by the diffuser, transmitted by said reflective polarizer, modulated by the modulation panel and finally projected by projection optics on e.g. a screen. In other words, light which at a first instance was considered unsuitable due to its polarization state is recycled and projected on the screen together with light initially having a desired polarization state. Consequently, a more light effective system is achieved and a brighter image is generated.

Alternatively, the polarizing means is a polarizing beam splitter, preferably arranged such that said modulation plate receives beam splitter redirected light, having said first polarization direction, and light having said second polarization direction is transmitted through said beam splitter. Further, a mirror is advantageously arranged behind said beam splitter such that beam splitter transmitted light, having said second direction of polarization, is reflected by the mirror back into the light guiding means for re-illumination of the modulation panel. This provides a compact, light efficient arrangement which is easy to align. Moreover, this arrangement is especially suitable when a reflective modulation panel is used.

Some advantages, which are obtained by the embodiments of the invention, have been described above. Similar advantages can also be achieved by corresponding embodiments of said optical element and said use.

The gist of the invention is to diffuse a first portion of a substantially confined illumination beam, having a first useful polarization direction, and reflect a second portion of the substantially confined illumination beam, having a second, undesired polarization direction. The reflection of the second portion should be performed in such a way that the reflected beam is kept as confined as possible. Preferably, this reflected light will eventually re-appear at the diffuser with a changed polarization state. Since the reflected light traverses an approximately three times as long light path before it re-appears at the diffuser and polarizer pair, compared to the instantly diffused and transmitted light, this light will result in a much higher homogeneous illumination field. Therefore, preventing the second polarization direction of the light from being diffused will improve the system light efficiency, while diffusing the other polarization direction will improve the homogeneity of the displayed image.

These and other aspects of the invention will be apparent from, and elucidated with reference to, the embodiments described hereinafter.

### BRIEF DESCRIPTION OF THE DRAWINGS

FIG. 1 schematically illustrates an image generating system according to one embodiment of the invention, arranged with a wave guide and a transmissive modulation panel.

FIG. 2 schematically illustrates an image generating system according to a second embodiment of the invention, arranged with a wave guide and a reflective modulation panel.

FIG. 3 schematically illustrates an image generating system according to a third embodiment of the invention, arranged with a three light valve optical system.

FIG. 4 schematically illustrates a direct view illumination system according to the invention.

FIG. 5 schematically illustrates an optical component according to a fifth embodiment of the invention.

### DESCRIPTION OF PREFERRED EMBODIMENTS

A description will be given of preferred embodiments according to the present invention in order to provide a better understanding of the invention. This is facilitated when this description is read in conjunction with the appended drawings. On the drawings like reference characters designate like or corresponding parts through out the schematic figures. The drawings are not drawn to scale.

All illustrated image generating systems suitably comprise conventional electronic circuitry for operating e.g. the light source and the image panel, which is known in the art and therefore is not described in more detail.

Although the invention is described in relation to a LCD based image generating systems, it is understood that it can also be used in other types of light modulating systems, e.g. an image projection system or a “direct view display” comprising a reflective liquid crystal silicon (LCOS) display panel.

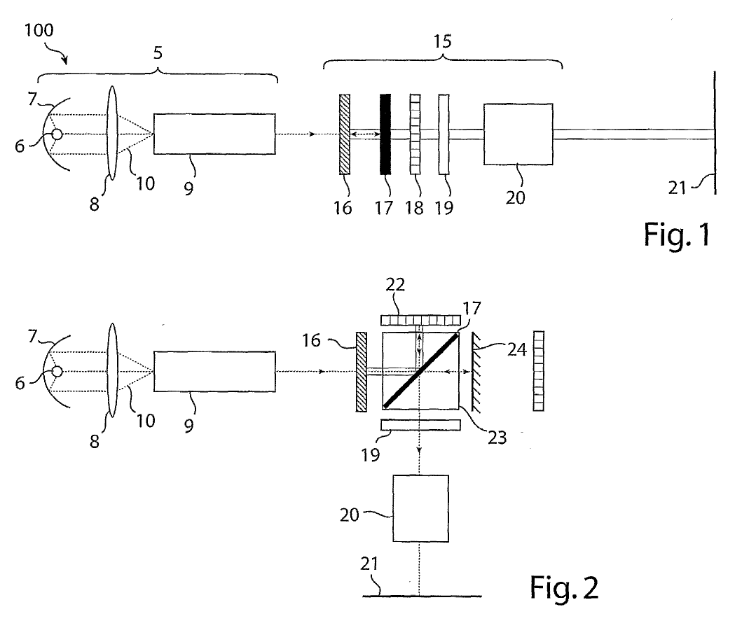

FIG. 1 is a schematic view of an first image generating system 1 comprising an illumination system 5 for providing an illumination beam and an image display system 15 for modulating an illumination beam 10. The illumination system 5 comprises a light source 6, a reflector 7, a condenser lens 8 and a light-guiding means 9, for example a rod of optically transparent material. The reflector 7 ensures that the greater part of the light, initially emitted by the light source 6 in a direction away from the light guiding means, reaches the image display system 15. The image display system 15 comprises a polarization dependent diffuser 16, a reflective polarizer 17, a transmissive LCD panel 18 or light modulation panel, an analyzer 19 and a projection lens 20. The polarization dependent diffuser 16 transmits and diffuses light emitted from the light source 6, which has a first polarization direction when it reaches the diffuser. Light emitted from said light source 6 having a second polarization direction is also transmitted by said diffuser 16, but this light is not diffused. After being transmitted, and possibly diffused, by the diffuser 16 the light reaches the reflective polarizer 17, which is functionally arranged between the diffuser 16 and the LCD panel 18. The polarizer 17 reflects light having said second polarization direction, i.e. light which has not been diffused by the diffuser 16, and transmits light which has said first polarization direction, i.e. light which has been diffused by the diffuser. The light, which is transmitted by the reflective polarizer 17, then proceeds to the transmissive LCD panel 18.

A transmissive LCD panel 18 comprises an array of LCD elements, wherein each element can be switched into a bright or dark state, e.g. by the application or removal of an electrical field. The difference between the two states is that in the bright state the emitted light has a first direction of polarization, and in the dark state the emitted light has a second direction of polarization, different from said first direction. Preferably, said first and second polarization direction is orthogonal to each other.

The analyzer 19 is arranged such that when one LCD element is in its bright state, light emitted from that LCD element is able to pass the analyzer. Further, the analyzer 19 is arranged such that when the LCD element is in its dark state, the emitted light will be blocked by the analyzer 19. An image can be generated by arranging some of the LCD elements in one of the two states, and the rest in the other, and illuminating the LCD array. The light transmitted by the analyzer will then carry image information, i.e. the illumination beam is modulated with image information and can be viewed, if the modulated illumination beam is projected e.g. on a screen 21.

The light reflected by the reflective polarizer 17 will pass the diffuser 16 a second time, without being diffused, and re-enter the light guiding means 9. Inside the light guiding means 9 the light will be recycled such that at least a portion of the light re-appears at the diffuser 16 having said first direction of polarization.

This light will then be diffused and transmitted by the diffuser 16, transmitted by the reflective polarizer 17, modulated by the LCD panel 18 and finally projected on the screen 21 by the projection optics 21.

The light-guiding means 9 is preferably made from a material, which depolarizes the light, but the light-guiding means 9 might also comprise birefringent films to ensure that the polarization direction of the light is changed when the light is recycling in the light-guiding system.

FIG. 2 illustrates a second embodiment of the invention, arranged in the same way as was described in relation to FIG. 1, except for the fact that a reflective LCD panel 22 is used instead of the transmissive LCD panel. Further, the reflective polarizer 17 is arranged as a polarizing beam splitter 23, such that light having said first polarization direction is reflected onto said reflective LCD panel 22, and light having said second polarization direction is transmitted straight through said beam splitter onto a mirror 24. The reflective polarizer 22 is arranged such that it, in its dark state, reflects the incoming light without shifting its polarization direction. Hence, this light will be reflected back towards the diffuser 16. Further, the reflective polarizer 22 is arranged such that, in its bright state, it shifts the polarization direction of the incoming light to said second polarization direction. Hence, this light will be transmitted straight through said beam splitter 23, without being redirected. Projection optics 20 is arranged on an opposite side of said beam splitter 23, compared to said reflective LCD 22. The projection optics 20 will project the light, which was reflected from the LCD 22 in its bright state on a screen 21.

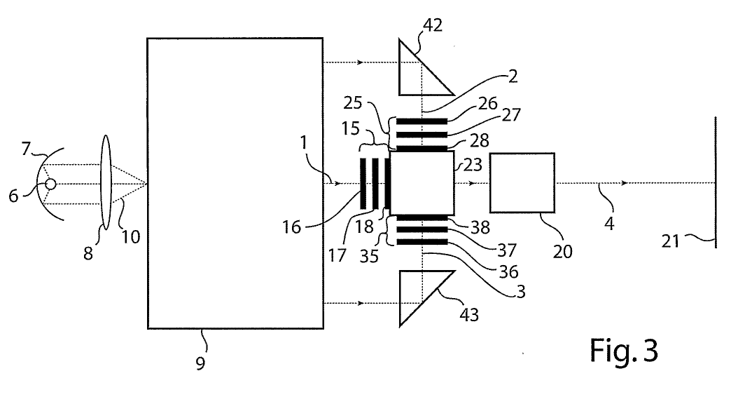

FIG. 3 illustrates a third embodiment of the invention, comprising three light valves. This embodiment is similar to what has been described in relation to FIG. 1, except for the fact that the light is divided into three channels inside the light guiding means 9, before it reaches a respective image display arrangement 15, 25,35 comprising a respective polarization dependent diffuser 16,26,36, a respective reflective polarizer 17,27,37 and a respective LCD panel 18,28,38. The green light traverses its respective image display arrangement 15 along a first optical axis 1. The red light traverses its respective image display arrangement 25 along a second optical axis 2, which is arranged orthogonal to said first optical axis. The blue light traverses its respective image display arrangement 35 along a third optical axis 3, which is arranged orthogonal to said first optical axis 1 and in an opposite direction to said second optical axis 2. The blue and red illumination beams are directed towards its image display arrangement by a respective folding prism 42,43. The light which is reflected by the reflected polarizer is directed back into the light guide 9 for recycling, as described in relation to FIG. 1.

A color combination element 23, such as an X-cube or dichroic prism, is arranged in the intersection point of the optical axes 1,2,3 such that each modulated illumination beam transmitted through the respective modulation plates 18,28,38, is combined into a multicolor modulated light beam along a single optical output axis 4. These are thereafter projected by projection optics 20 such as a projection lens, onto a screen 21.

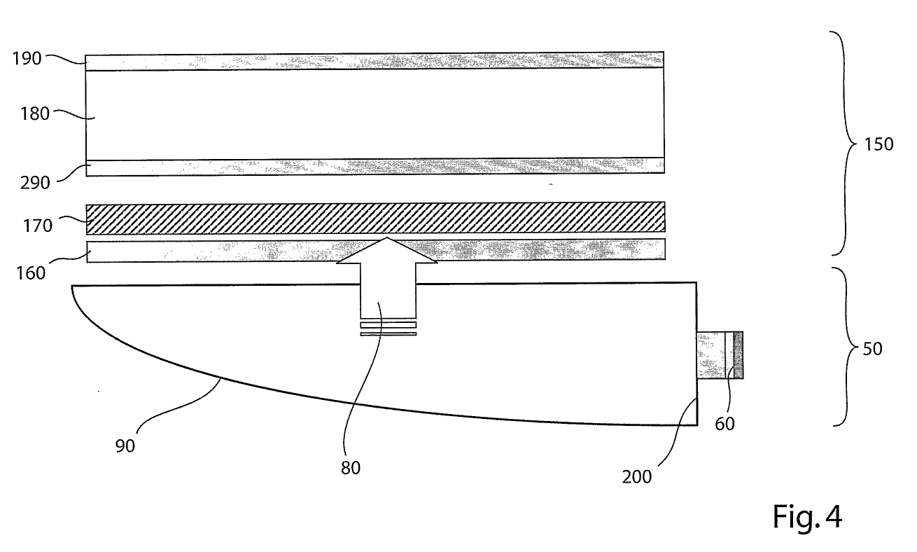

FIG. 4 illustrates a direct view LCD device comprising an illumination system 50 for providing an illumination beam and an image display system 150 for modulating an illumination beam 80, before it reaches the eye of an observer. The illumination system 50 comprises a light-source 60, a reflector pattern 370 and a light guiding means 90, formed e.g. of an optically transparent material. The light source 60 might e.g. comprise a number of fluorescent tubes; or one or more LED light sources, for example a group of red LEDs, a group of green LEDs and a group of blue LEDs; or a group of white LEDs. In this embodiment the light source 60 comprises a group of white LEDs, the light of which is emitted into the light guiding means 90 through an entrance surface 200. The entrance surface 200 forms a reflective inner wall of the light guiding means. The part of the entrance surface, which is arranged in front of the illumination source, is provided with small holes such that a major part of the illumination source emitted light can pass into the light guiding means through these.

As can be seen in the figure the light guiding means is arranged to provide a homogeneous illumination in a direction which is orthogonal to the principle emission direction of the light source. Such light guides are known in the art, and will not be described further.

The image display system 150 comprises a polarization dependent diffuser 160, a reflective polarizer 170, a transmissive LCD panel 180 or light modulation panel, and an analyzer 190. These are arranged and operates in the same way as was described in relation to FIG. 1, i.e. the incident light having a first polarization direction is diffused and transmitted towards the LCD panel. The light having a second, different, polarization direction is reflected back into the light guiding means.

The reflected light will pass the diffuser 160 a second time, without being diffused, and re-enter the light guiding means 90 with such an angular light-distribution that this re-entering light is efficiently reflected back to the entrance surface 200, without any major light-losses in the system. The light effectiveness is mainly due to that the angular distribution of this light is hardly changed by the diffuser 160. Further, the re-entering light will homogeneous illuminate the entrance surface, and a major part of the re-entering light will hit a reflective portion of the entrance surface 200. Hence, this light is recycled, i.e. at least a portion of the light re-appears at the diffuser 160 having said first direction of polarization.

Preferably, the light-guiding means 90 is made from a material which depolarizes the light. It may also comprise birefringent films, in order to ensure that the polarization direction of the light is changed when the light is recycling in the light-guiding system. Additionally, an absorption type of polarizer 290 might be applied between the reflective polarizer 170 and the light modulation panel 180, in order to increase the contrast of the display system in case that the degree of polarization of the reflective polarizer 170 is insufficient. Such a polarizer can also be used in other embodiment of the invention, e.g. those described in relation to FIGS. 1-3.

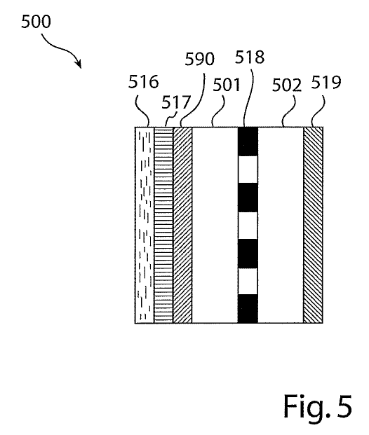

FIG. 5 is a schematic view of an embodiment of an optical component 500 comprising a first glass substrate 501 provided with a diffusing layer 516 and a polarizing layer 517. The diffusing layer 516 is arranged such that it transmits substantially all incident light, while it only diffuses light having a first polarization direction. The polarizing layer 517 is arranged such that it transmits light having said first polarization direction, and reflects light having a second polarization direction. In this embodiment the two layers are arranged on the same side of the substrate 501, and the diffusing layer 516 is arranged on top of the polarizing layer 517 which is arranged on the substrate. It is also possible to arrange the diffusing layer 516 and the reflecting layer on two opposite sides of the substrate 501. Further, an absorbing polarizing layer 590 can be arranged on the substrate 501, such that the reflective polarizing layer 517 is arranged between said diffusive layer 516 and said absorbing polarizing 590. Preferably, all three layers 516,517,590 are arranged on the same side of said substrate.

Optionally, a light modulation layer is sandwiched between said first substrate 501 and a second glass substrate 502. This is preferably performed before the diffusing and polarizing layer is arranged on the first substrate. Moreover, an analyzer layer 519 can be provided on said second substrate 502, preferably on a side opposite to said light modulation layer 518.

In summary, what has been described above are different embodiments of display devices, which provide both an improved image homogeneity as well as a higher light effectiveness, although the two properties are generally considered hard to provide at the same time. It is achieved by the introduction of a polarization dependent diffuser before a reflective polarizer in the light path between light source and the LCD panel, in the display device system. The image quality is improved since the diffuser broadens light incident on the LCD panel. The light effectiveness is improved as the polarizer reflects confined, non-diffused light, such that it can be recycled by light guiding means, in the display device, for re-illumination of the image display panel.

In this document the word “comprising” does not exclude other elements or steps, the word “a” or “an” does not exclude a plurality, and a single component may fulfill the functions of several means recited in the claims.

1. A display device comprising:
an illumination system (5) for providing an illumination beam (10);
a modulation panel (18) for modulating the illumination beam with image information;
diffusing means (16), for diffusing a first portion of the illumination beam having a first polarization direction and transmitting a confined second portion of the illumination beam having a second polarization direction; and
polarizing means (17), functionally arranged between said diffusing means (16) and said modulation panel (18), for transmitting said first portion of the illumination beam to said modulation panel (18), and preventing said second portion of the illumination beam from reaching said modulation panel (18).

2. A display device according to claim 1, wherein said display device is an image projection system further comprising projection means (20) for projecting said modulated illumination beam on a screen (21).

3. A display device according to claim 1, wherein said display device is a direct view system.

4. An image projection system according to claim 2, wherein said polarizing means (17) is a reflective polarizer, arranged such that it reflects said second portion of the illumination beam back into the illumination system for recycling.

5. An image projection system according to claim 2, wherein said polarizing means is a polarizing beam splitter (23) for directing light having said first polarization direction in a first direction towards said modulation panel (22), and light having said second polarization direction in a second direction, different from said first direction.

6. An image projection system according to claim 5, further comprising a mirror (24) arranged such that light forwarded in said second direction is reflected back into said illumination system.

7. An image projection system according to claim 1, wherein a dichroic color filter is arranged between said diffuser means and said polarizing means.

8. An image projection system according to claim 1, wherein said modulation panel is an LCD panel.

9. An optical element, for use in an image projection system as defined in claim 1, comprising a substrate (501) provided with:
a first layer (516) for diffusing light having a first polarization direction, and transmitting light having a second polarization direction, and
a second layer (517) for transmitting light having said first polarization direction and reflecting light having said second polarization direction, wherein said layers preferably are arranged on opposite sides of said substrate.

10. An optical element according to claim 9, further comprising a third light modulating layer (590), wherein said second layer (517) is arranged between said first layer (516) and said third layer (590).

11. Use of a polarization dependent diffuser (16) in a image projection system for improving homogeneity of an illumination beam incident on a modulation panel (18), arranged for modulating an illumination beam with image information, wherein said diffuser (16) diffuses a first polarization direction of said illumination beam and transmits a second polarization direction of said illumination beam.

12. Use according to claim 11, wherein said diffuser is used in front of a polarizing component (17) in the illumination beam path, which preferably is a reflective polarizer reflecting said second polarization direction.
